(19) United States
(12) Patent Application Publication
(10) Pub. No.: US 2012/0078733 A1
(43) Pub. Date: Mar. 29, 2012

(54) SYSTEM AND METHOD FOR MANAGING ADVERTISING CAMPAIGNS

(75) Inventors: Massimiliano Visinoni, Carate Brianza (IT); Giacomo Di Benedetto, Monza (IT); Davide Bocelli, Fidenza (IT)

(73) Assignees: Massimiliano VISINONI, CARATE BRIANZA (IT); Marco BELLINI, OLBIA (IT)

(21) Appl. No.: 13/375,006

(22) PCT Filed: Jun. 18, 2009
(86) PCT No.: PCT/IT2009/000266

§ 371 Date: Nov. 29, 2011

(51) Int. Cl. G06Q 30/02

(52) U.S. Cl. 705/14.73

(57) ABSTRACT

A system for telematic management of advertising campaigns comprises a central server connected to a database that contains identification data of advertising sites associated with a plurality of operators, the identification data comprising operating parameters associated with each one of the sites; a plurality of user stations, suitable to interact with the central server via a telematic network and comprising a data entry interface for defining an advertising campaign; a processing engine, located at the central server, which is configured to associate automatically with the advertising campaign, on the basis of the definition data of the advertising campaign and of the identification data, one or more of the advertising sites.

### TECHNICAL FIELD

The present invention lies in the field of the management of advertising spaces, with particular reference to advertising spaces commonly available in streets, stations, airports and public spaces in general.

### BRIEF DESCRIPTION OF RELATED ART

Advertising is often defined as the soul of business. The success of a product or service, no matter how valuable, requires first of all potential customers to become aware of the existence of the product or service, to remember it over time, and to have their own positive subjective perception of the product or service offered at the time when it might be of interest to them.

All this comes together in the creation of an advertising campaign. The planning of an advertising campaign defines, on the basis of a budget that is allocated for this purpose by the advertiser, how many and which advertising spaces to use and how long to use them. Typically, an advertising space that is very visible due to its position and/or size and is located in an area where a considerable number of people pass allows to reach a broader audience than an advertising space that is less visible or located in less frequented locations. However, such a space, which is unquestionably more desirable, normally attracts a higher bill-posting charge, which reduces the total time of exposure of the advert with respect to a less valuable space. In planning an advertising campaign it is therefore essential to assess carefully which spaces to use and for how long, an activity that usually requires the intervention of a professional in the field or, more generally, of an advertising agency.

Advertising spaces, hereinafter referenced in this text by the term “sites”, are typically managed by a certain number of agents. For the sake of simplicity in description, it is assumed that the total of the advertising sites is partitioned, i.e., divided without overlaps, among the agents. The role of the agent is substantially to rent the sites to advertisers, keeping track constantly of which sites are free or occupied in order to be able to assign them to an advertiser that requests them.

When an advertiser contacts an agency to request the creation of an advertising campaign, the agency assesses, on the basis of the requirements of the advertiser, which advertising sites to use and for how long to use them. The agency then asks the several agents for the availability of sites that have the desired characteristics and returns to the advertiser a list of results related to the sites that will carry the campaign.

However, this process suffers considerable drawbacks. On the one hand, each agent stores and rates the sites that it manages according to its own standards and parameters, which are not shared with the other agents. Moreover, the splitting of the advertising sites among the different agents does not allow an agency to know whether the sites that it believes useful for the campaign being defined are available as a whole, since the agency has to request individually the availability to each agent and wait for the corresponding answer, to then verify the quality of the bid or try to fit together the resulting availabilities and re-plan part of the campaign on other sites if they are not available. Moreover, even when the sites are available, it is not possible to identify precisely which sites have actually been assigned following the request made. Therefore, the planning of an advertising campaign is not only an extremely slow and convoluted process, but even once it has been defined it is not possible to achieve an exact perception of the location of the billboards.

All this entails a considerable expenditure of time and costs, which affects negatively the budget allocated for the advertising campaign and does not allow to obtain optimum results.

### BRIEF SUMMARY

The aim of the present invention is to overcome the limitations of the background art highlighted above by devising a method and a system that allow to plan an advertising campaign quickly and with precise results.

Within this aim, invention allows immediate access to site availability independently of the agent who is responsible for the site.

The invention further obtains automatically an optimum planning of an advertising campaign on the basis of the requirements of the advertiser.

The invention makes visible and easily perceivable by the advertiser the sites assigned for its advertising campaign, further allowing immediate modifications and variations thereof.

The invention also provides a system that is simple to apply and implement and can be integrated easily with existing systems.

The invention comprises a system for telematic management of advertising campaigns, comprising a central server connected to a database that contains identification data of advertising sites associated with a plurality of operators, said identification data comprising operating parameters associated with each one of said sites; a plurality of user stations, adapted to interact with said central server via a telematic network and comprising a data entry interface for defining an advertising campaign; a processing engine, located at said central server, which is configured to associate automatically with said advertising campaign, on the basis of said definition data of said advertising campaign and of said identification data, one or more of said advertising sites.

The invention provides a method for the telematic management of advertising campaigns, comprising the steps of: collecting, in a database located at a central server connected to a telematic network, identification data of advertising sites associated with a plurality of operators, said identification data comprising operating parameters associated with each one of said sites; receiving, from a plurality of user stations designed to interact with said central server via said telematic network, data that define an advertising campaign; on the basis of said definition data of said advertising campaign and of said identification data, associating one or more of said advertising sites with said advertising campaign.

### BRIEF DESCRIPTION OF THE DRAWINGS

Further characteristics and advantages of the invention will become better apparent from the description of a preferred but not exclusive embodiment of the system and method for managing advertising campaigns, illustrated by way of non-limiting example in the accompanying drawings, wherein:

FIG. 1 is a block diagram related to the architecture of the system according to the present invention;

FIG. 2 is a block diagram that illustrates in greater detail an aspect of the architecture of the system according to the present invention;

FIG. 3 is a block diagram that illustrates the system for converting the data supplied by the agents to the operator of the service according to the present invention;

FIG. 4 is a block diagram that illustrates the steps of communication among clients, agencies, agents and operator of the service according to the present invention;

FIGS. 5A and 5B are a flowchart that illustrates in greater detail the algorithm for selecting the optimum advertising campaign according to the present invention;

FIG. 6 is a view of an exemplifying embodiment of a graphical interface for entering the selection criteria of an advertising campaign according to the present invention;

FIG. 7 is a view of an exemplifying embodiment of a graphical interface for displaying selection results of an advertising campaign according to the present invention;

FIG. 8 is a view of an exemplifying embodiment of a graphical interface for an alternative visualization of results of the selection of an advertising campaign according to the present invention.

### DETAILED DESCRIPTION

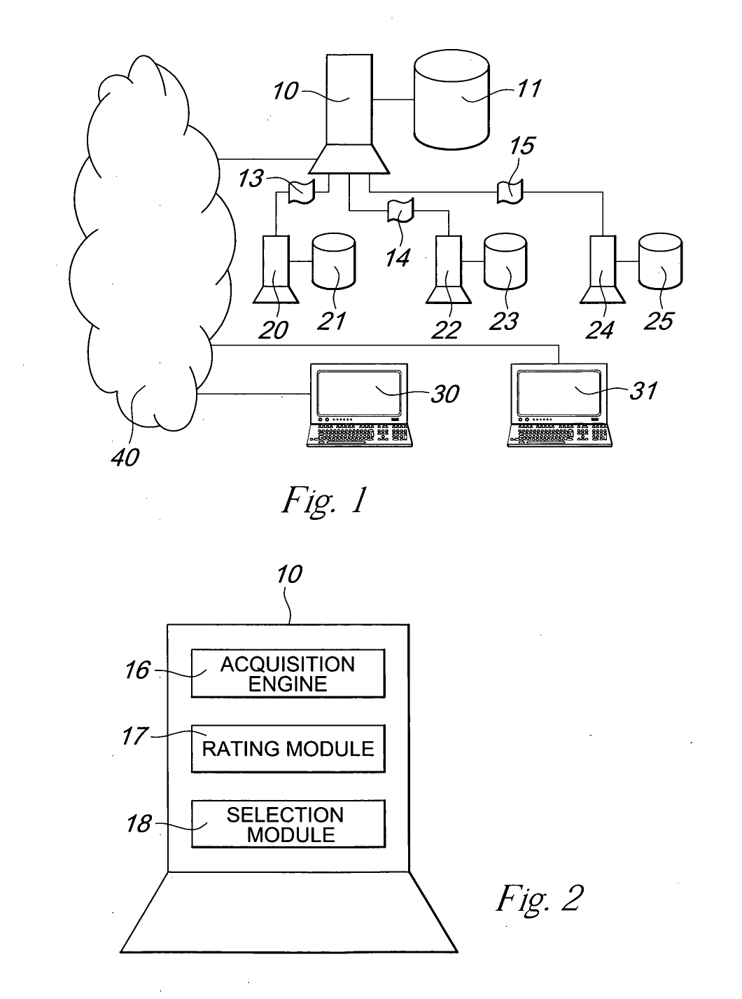

An exemplifying architecture of the system according to the present invention is summarized in the block diagram of FIG. 1.

The figure illustrates a computer of the service operator 10, a plurality of computers of advertising agents 20, 22 and 24, and a plurality of computers of users of the service 30 and 31, which are representative in particular of advertisers or advertising agencies.

The computer 10 of the service operator is representative of an architecture of the server type. The server 10 comprises, or has access to, memory or storage means 11, which can comprise a database or any data structure adapted to store permanently information related to the advertising sites of all the agents registered with the service.

Each computer of advertising agents 20, 22 and 24 in turn comprises, or has access to, memory or storage means 21, 23 and 25. Like the storage means 11, the memory means 21, 23 and 25 also comprise a database or other data structure adapted to store permanently information related to the advertising sites belonging to the individual agent. The formats of the data stored in the storage means 21, 23 and 25 may be any and need not necessarily be mutually compatible or correspond to the format of the storage means 11. For example, the data can be stored in relational databases, spreadsheets or XML files, according to proprietary formats.

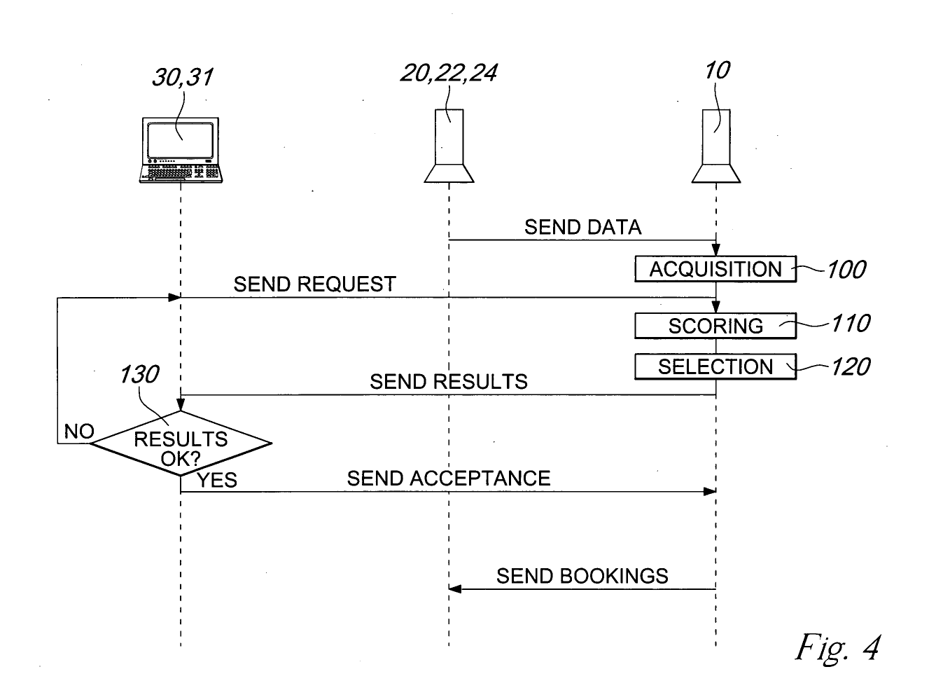

Each agent computer 20, 22 and 24 can be connected to the computer of the service operator 10. The connection can occur via any telematic network, for example the Internet, or via a dedicated communications line. Downstream or upstream of the communication, converter means 13, 14 and 15 are provided for sending, converting and normalizing some data of the individual agents, as will become better apparent with reference to FIG. 3.

The converter means 13, 14 and 15 are customized means defined for each agent, i.e., a specifically provided conversion module is provided which is adapted to convert data of interest, stored in the memories 21, 23 and 25 of the agents, from the format that is used by a specific agent into data that are normalized according to a format that is defined at the operator's server 10. Moreover, communication between the agents and the server 10 is to be understood figuratively, since physical communication can occur via any communications network or even in offline mode, for example by means of the transfer of the data on a magnetic, optical or other medium.

Each computer of a user of the service 30, 31, be it an advertising agency or an advertiser, that wishes to plan an advertising campaign, is representative of a client station that is adapted to communicate with the server 10, i.e., the computer of the service operator, via a communications network 40. In a preferred embodiment, the communications network 40 is the Internet, but it is possible to provide for use of the invention also on an intranet or extranet or on any private network that is adapted to implement a client/server relationship. Each computer of a user of the service 30 or 31 accommodates a client module, not shown in the figure, by means of which the user can enter suitable parameters in order to query the server of the service operator 10 and receive the results of the query; the client module can comprise for example a web application or a rich client.

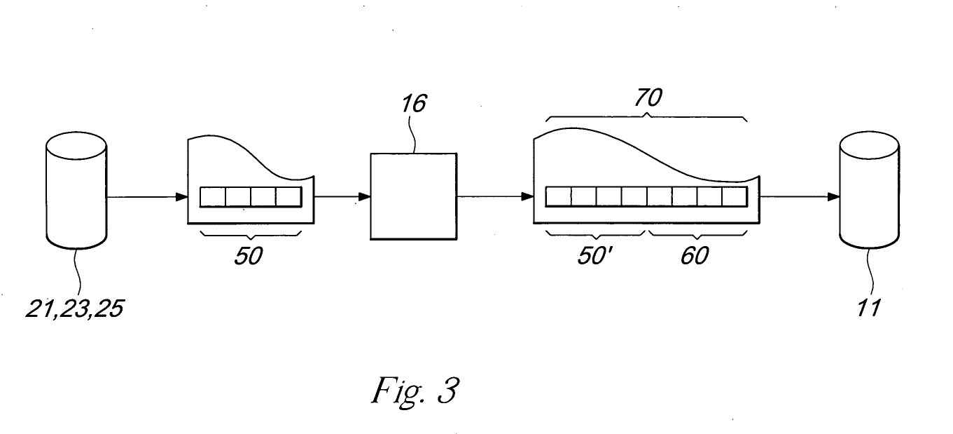

FIG. 2 illustrates in greater detail the architecture of the server of the service operator 10 according to the invention of FIG. 1. In particular, the server 10 comprises an acquisition engine 16, a rating module 17 and a selection module 18.

The acquisition engine 16 acts as an interface with the communication lines or the converter means 13, 14 and 15 and comprises, for each line, a specific acquisition module, which is adapted to acquire the data contained in the storage means 21, 23 and 25 of an individual agent. The acquisition engine 16 may further comprise means for reflecting in the storage means 11 the updates applied to the content of the storage means of the individual agents 20, 22 and 24 every time they are made. Said means can be for example implemented with techniques for polling on the part of the computer of the service operator 10 or by means of asynchronous messaging services on the part of the computers of the agents 20, 22 and 24.

The rating module 17 comprises means for generating, given a request by the client, a rating of the sites stored in the storage means 11 on the basis of their identification data and of the constraints and of the preferences set by the client. The rating module 17 is generally configured to assign a score to each site and therefore a position in the rating.

The selection module 18 comprises means for selecting, among the sites that are present in the storage means 11, in cooperation with the rating module 17, a set of sites that best meet a request of an advertising campaign.

FIG. 3 is a view of the methods for importing and converting the data from the storage means 21, 23 and 25 of the agents to the storage means of the service operator 11. The figure illustrates in particular a record 50, this term referencing a set of fields and attributes related to a specific advertising site, such as its location, size, rental cost and type. The record 50 is passed in input to the converter module 16, which converts and normalizes the data contained in the record 50 according to the specifications of the storage means 11. By way of non-limiting example, this conversion can comprise the mapping of the data of the agent onto the data scheme of the operator, a conversion of units of measure, for example from inches to centimeters for size, the aggregation or splitting of distinct fields. For example, any “length” and “width” fields might be aggregated into a single “surface” field. Moreover, each field is preferably normalized according to an appropriate normalization function, for example a linear, logarithmic or exponential one, so as to obtain an adequately concentrated normalization scale. By way of example related to the dimensions of the site, the difference between a site measuring 600×300 cm and one measuring 140×100 cm would be so large that it would to a very spread scale. In such cases, the system conveniently provides for the use of a logarithmic normalization scale. In particular, in a preferred embodiment, the values of the parameters range from 1 to 100 and the real values are projected onto said scale.

The person skilled in the art easily understands that these conversion operations can also include checks to verify the correctness, consistency and completeness of the data being acquired. As mentioned previously, the acquisition engine 16 comprises a dedicated acquisition module for each agent or for each data format used to store the data in the storage means 21, 23 and 25. The acquisition module can be implemented in a variety of ways and programming languages: for example, the data might be encoded in XML language and converted by means of an XSLT transformation or in CSV format and processed by a sequential program.

The result of the transformation is the record 70, which comprises a portion 50′, which corresponds to the fields contained in the input record 50, appropriately normalized, and a portion 60, which comprises additional parameters entered by the service operator, which are useful or necessary for the subsequent rating and selection operations. The record 70 is then stored, together with the other records of the same agent and with records that originate from other agents, in a single database within the storage means 11.

By way of example, Tables 1 and 2 respectively illustrate two examples of records 50 (for the sake of simplicity, only a portion of said records is shown) as stored at two separate agents, and Table 3 illustrates a possible mode of conversion and importing of said records in the database according to the invention in the form of a record 70.

TABLE 1

| Address | Type | Municipality |
|---|---|---|
| Via Arona, Intersection | 6 × 3 m poster | Rozzano |
| with Via Bolzano | | |

TABLE 2

| Street | Address | Street no. | Type | Province | Municipality |
|---|---|---|---|---|---|
| V.le | Monza | 21 | Poster, | Milan | Milan |
| | | | 600 by 300 | | |

TABLE 3

| ID | 1002 | 1003 |
|---|---|---|
| Original address | Via Arona, Intersection | V.le Monza 21 |
| | with Via Bolzano | |
| Address | Via Arona 109 | Viale Monza 21 |
| Municipality | Rozzano | Milano |
| Postcode | 20089 | 20127 |
| Province | Milan | Milan |
| Region | Lombardy | Lombardy |
| State | Italy | Italy |
| Type | Poster | Poster |
| Format | 600 × 300 | 600 × 300 |
| Lon | 1008.16.00 | 551.59.00 |
| Lat | 258.43.00 | 354.07.00 |

Both records listed in Tables 1 and 2 contain information regarding the location and size of the site, but the number and type of fields used, as well as the units of measure, are different.

The normalized records listed in Table 3 contain the information given in the source records, described in a uniform manner, such as “address”, “municipality”, “province”, “type”, “format”. Moreover, they contain additional information, such as “ID”, “postcode”, “region”, “state”, “longitude”, and “latitude”.

Information related to the original formatting of the fields is also preferably stored in the “Original address field”, so that the imported records continue to be significant in the specific semantics of the agents from which they originate.

The person skilled in the art can consider easily a similar importing and conversion method as regards the fields containing information related to site prices.

In one preferred embodiment, a site is characterized by a set of public fields or parameters, by a set of private parameters and by a set of confidential parameters.

The parameters defined as “public” comprise site attributes that are visible to all the players involved in the planning process, i.e., the advertisers, the agents and the service operator. As will be described in detail hereinafter, the advertisers can view these parameters and can attribute to each of them a weight, i.e., the importance of each parameter in determining the desirability of the site.

In one embodiment, a site comprises the fields listed in Table 4.

TABLE 4

| FIELD NAME | TYPE |
|---|---|
| ONECLICK SITE CODE | Alphanumeric |
| STATE | Alphanumeric |
| REGION | Alphanumeric |
| PROVINCE | Alphanumeric |
| MUNICIPALITY | Alphanumeric |
| POSTCODE | Alphanumeric |
| STREET | Alphanumeric |
| GPS COORDINATE 1 | Numeric or alphanumeric |
| GPS COORDINATE 2 | Numeric or alphanumeric |
| GPS COORDINATE 3 | Numeric or alphanumeric |
| GPS COORDINATE 4 | Numeric or alphanumeric |
| MUNICIPALITY CLASS | Numeric (1 to 5) |
| RESIDENT POPULATION OF | Numeric |
| MUNICIPALITY | |
| RESIDENT POPULATION OF PROVINCE | Numeric |
| TARGET POPULATION (PR RESIDENTS + | Numeric |
| COMMUTERS) | |
| COVERAGE | Numeric |
| PERCENTAGE COVERAGE | Numeric |
| FREQUENCY | Numeric |
| CONTACTS | Numeric |
| GRP | Numeric |
| INPE CODE | Numeric |
| INTERNAL AGENT CODE | Alphanumeric |
| AGENT/MUNICIPALITY ID | Alphanumeric |
| SITE ID (poster/special/maxi) | List |
| SITE TYPE (poster, bus stop, | List |
| shelter, etc.) | |
| SITE TYPE DESCRIPTION (simple, | List |
| lit, backlit) | |
| SITE SPECIFICATION (single/two- | List |
| sided/rotor etc.) | |
| SITE CIRCUIT NAME | List |
| SITE PHOTO | Image |
| DISCOUNT | Numeric |
| NET | Numeric |
| D.A. | Numeric |
| NET. NET. | Numeric |
| DN | Numeric |

The data thus defined can be grouped in order to optimize the system according to the invention. In particular, the sites can be rented individually or grouped into circuits to be rented collectively. The circuits can be distributed according to criteria of uniformity within a territory, for example within a single city. Aggregation into circuits can make the management and assignment of said sites more effective, reducing the number of free data items during the selection of the sites for an advertising campaign.

The system can provide, for the same purpose, additional constraints. The sites might be assigned for predefined time periods, for example in two-week blocks.

Some of the most significant fields listed in Table 4 are described in detail hereinafter.

Size of the site: sites always have an associated surface, which indicates the surface of the advertising billboard that they contain. All other parameters being equal, the larger the size of the site, the better the site. In general, in a circuit is it is preferable to introduce sites that are substantially uniform in terms of surface. If they are not, one can consider as representative the average surface of the site.

Unit price: this indicates the charge of the individual site: for a circuit, it is again the average price of the representative site. In this case, other parameters being equal, the lower the price, the higher the convenience in considering the site. It is further possible to provide for the use of the unit price as a unit price per square meter, so as to be able to compare the prices of sites of different sizes.

GRP: this is the most common impact indicator used in advertising. It is expressed as a percentage and indicates the number of contacts with respect to the total audience. For example, a GRP of 345 and an audience of one million people indicates that 3450000 contacts have been achieved. Once again, other parameters being equal, a higher GRP is preferable to a lower GRP.

Coverage (and percentage coverage): GRP is not sufficient to determine the impact of an site. Without knowing the audience, it is in fact not possible to determine the actual number of contacts. Coverage and percentage coverage are additional parameters that influence the rating of the site. Coverage indicates the number of people reached by the advertisement, while percentage coverage indicates the percentage of the coverage with respect to the audience. In this manner, by adding these two parameters it is possible to calculate the site's audience and frequency, i.e., the number of times a same person has been contacted by the site. Other parameters being equal, the higher the coverage, the better the site.

Discount: this is a fundamental parameter in commerce. The system is preferably configured so as to keep separate the parameters that indicate the overall cost and the discount. The value of the discount variable is a function that depends on the distance between the period of purchase and the booking period, i.e., the shorter the distance the higher the discount, with respect to the agreements made by the operator of the service with the various agents, and on the unsold percentage of a site in a given period. Of course, other parameters being equal, the higher the discount the better the site is considered.

The parameters classified as “private” comprise parameters that are visible only to the operator of the service and to the agents: these parameters allow to take into account, in the optimum allocation of an advertising campaign, not only the requirements of clients but also the requirements of agents. These parameters allow for example, other parameters being equal, to assign a higher rating to sites that agents wish to promote. By way of example, a private parameter with these characteristics can be the annual unsold percentage: this percentage can be calculated by the agents or by the operator on the basis of the sales of the preceding years. The reasons for the unsold may be different and may be due to the quality of the site, to its location, to the seasonality of the city or also to the fact that manually organized campaigns may, perhaps out of habit, always use the same sites. It is obviously in the interest of an agent to minimize the unsold percentage, and the rating algorithm can take this into account by assigning, other parameters being equal, a higher rating to sites with a higher unsold percentage. Vice versa, users of the service cannot determine the weight to be assigned to this parameter and in general are not aware of it.

Finally, the parameters classified as “confidential” comprise parameters that are visible only to the operator of the service: like the private parameters, these parameters allow to assign a higher rating, other parameters being equal, to sites that it is in the interest of the service operator to promote on the basis of the operator's agreements with the agents. By way of example, a confidential parameter might be the annual residual value of the agent; this parameter assumes that the service operator has committed to purchase advertisements for a certain amount from a given agent through the year and indicates the amount currently not yet used. It is therefore in the interest of the service operator to assign a higher rating to the sites of the agents with which said residual value is higher.

The public, private and confidential parameters listed above are the ones that in the preferred embodiments are considered most significant for optimization of an advertising campaign. However, it should be noted that the method according to the invention, as will be described in detail hereinafter, is independent of which and how many parameters are actually used.

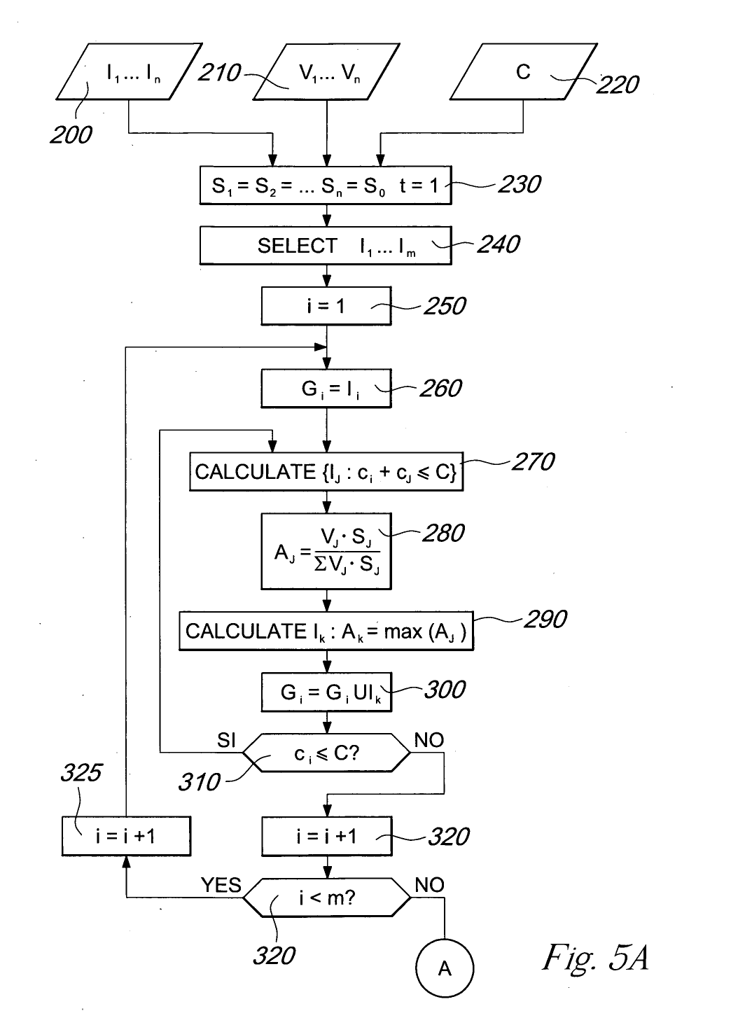

With reference to FIG. 4, the steps of communication between users 30 and 31, agents 20, 22 and 24 and service operator 10 in order to provide the planning of an advertising campaign according to the present invention are now described in detail.

Prior to the use of the system by the users 30 or 31, the agents 20, 22 and 24 send to the service operator 10 the data related to the advertising sites that belong to them, which in step 100 are subject to acquisition by the acquisition engine 16 in the manners described earlier. As previously mentioned, the acquisition step can also comprise the subsequent updates and can provide for a periodic frequency or an event-driven frequency.

Once the database has been populated with the data related to the sites of the agents that subscribe to the service, the service operator 10 is available to receive requests from users: typically, a request is composed of a set of constraints, such as the available budget and the period requested for the campaign, and a set of weights: the user can associate with each public parameter a weight, for example a value comprised between −1 and 1 and such that the sum of the weights taken in absolute value is equal to 1, indicating the importance of that parameter in determining the desirability of a site. For example, if a parameter, such as size, is deemed very important and a larger size is considered more desirable by the user, the user will assign a weight close to 1 to it, whereas if one desires the unit price to be lower, the user will assign a weight close to −1 to this parameter. Finally, a weight equal to 0 will be assigned to all the parameters deemed irrelevant.

The set of weights sent by the user is used by the service operator 10 in order to execute a scoring algorithm in step 110: the scoring algorithm allows to assign to each site that meets the constraints set by the user a score and therefore is used to write a chart of the sites based on their desirability according to the weights set by the user. In a preferred embodiment, the scoring algorithm calculates the value V for each site on the basis of the formula:

V=Σwᵢ*Pᵢ

where Pᵢ is the i-th parameter and wᵢ is the relative weight set by the user.

The sorting of the values V thus obtained produces a chart. The person skilled in the art easily understands that it is possible to provide alternative scoring algorithms without abandoning the scope of the protection of the present invention.

Once the chart of the sites that meet the constraints has been obtained, in step 120 the service operator 10 selects the best subset thereof that meets the budget of the client, i.e., a selection that approaches as closely as possible the allocated budget and with the highest possible average scoring value.

At the end of the processing, the service operator 10 sends to the computer of the user 30 or 31 the results of said processing. At this point, in step 130 the user determines whether the results can be considered satisfactory: if they are, the user sends to the service operator an acceptance message, i.e., a booking of the sites selected by the service. The service operator can then generate from the acceptance messages booking requests, which are notified to the agents to which the selected sites belong. If the user does not deem the selection satisfactory or wishes to evaluate alternative ones, he can send a new request, changing appropriately the weights of the parameters and/or the constraints.

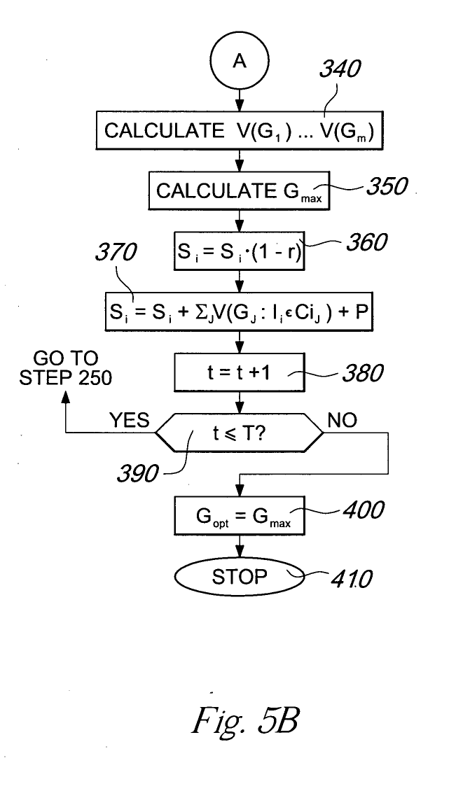

FIG. 5, which is divided into FIGS. 5A and 5B, illustrates in greater detail the step 120 for selecting the optimum site group according to the invention.

In a preferred embodiment, the step 120 is implemented by means of a heuristic search algorithm based on known ants colony optimization algorithms. The goal of the algorithm is to select the group of sites that best approximates the allocated budget and at the same time obtains the highest possible score, determined by the mean of the scores of the sites calculated in the scoring step 110.

The operation of the algorithm is as follows: the algorithm receives in input the set 200 of the n sites I₁ . . . Iₙ registered in the storage means 11, their scores V₁ . . . Vₙ 210, calculated in the scoring step 110, and the budget C allocated by the customer 220.

In step 230, the selection module 18 assigned to each one of the n sites an initial selectability value S₀, which will be updated at each step of the optimization; in a preferred embodiment, said initial value is equal to 0.5.

In step 240, the selection module 18 selects a set of m initial sites, with m<=n.

In step 250, the selection module considers the first site of the set and in step 260 sets as a first group the group of sites that contains initially only the first site.

In step 270, the selection module 18 calculates the set of sites that can be added to the group, i.e., are such that the sum of the prices of the sites of the group and of the added site does not exceed the budget.

In step 280, the selection module 18 calculates the desirability value of each one of the sites that can be added to the group, given by the score V of the site multiplied by the selectability value and normalized to the sum of said values for the sites that can be added for that group, according to the formula:

$${A}_{j} = \frac{{V}_{j} * {s}_{j}}{{\sum }_{j}}$$

In step 290, the selection module 18 selects the site, among the ones that can be added, that has the highest desirability and in step 300 it adds it to the group.

In step 310, it calculates whether the group that has been assembled so far has a cost that is lower than the budget C: if so, control returns to step 270 for the addition of a new site to the group. If instead the budget has been reached, in step 320 the selection module 18 moves on to consider the next initial site, and therefore control returns to step 260 for the creation of a new group in the same manner.

Once all the m groups have been generated, in step 340 the selection module 18 calculates the score of each group, determined by the mean of the scores of the individual sites that belong to the group, and then in step 350 it selects the group that has the highest score.

In step 360, the selection module 18 reduces the selectability values currently used by a factor r, i.e., it sets si=si*(1−r); in a preferred embodiment, r is equal to 0.2; this factor is used to “forget” at each subsequent pass the results obtained earlier, in order to prevent the algorithm from falling on local maximums.

In step 370, the selection module 18 recalculates the selectability values of the sites: for each site, the new value is determined by the preceding selectability value, to which the sum of the scores of the groups in which the site occurs and an additional premium if the site appears in the group with the highest score are added.

The sequence described so far is repeated a number T times: in step 380, the selection module 18 increases the number of passes performed and in step 390 checks whether this is lower than the set number of passes T: if it is not, in step 400 the group with the highest score is set as optimum group and returned in output to the user, and then the algorithm ends in step 410; if it is, control returns to step 250 for the generation and evaluation of a new set of groups.

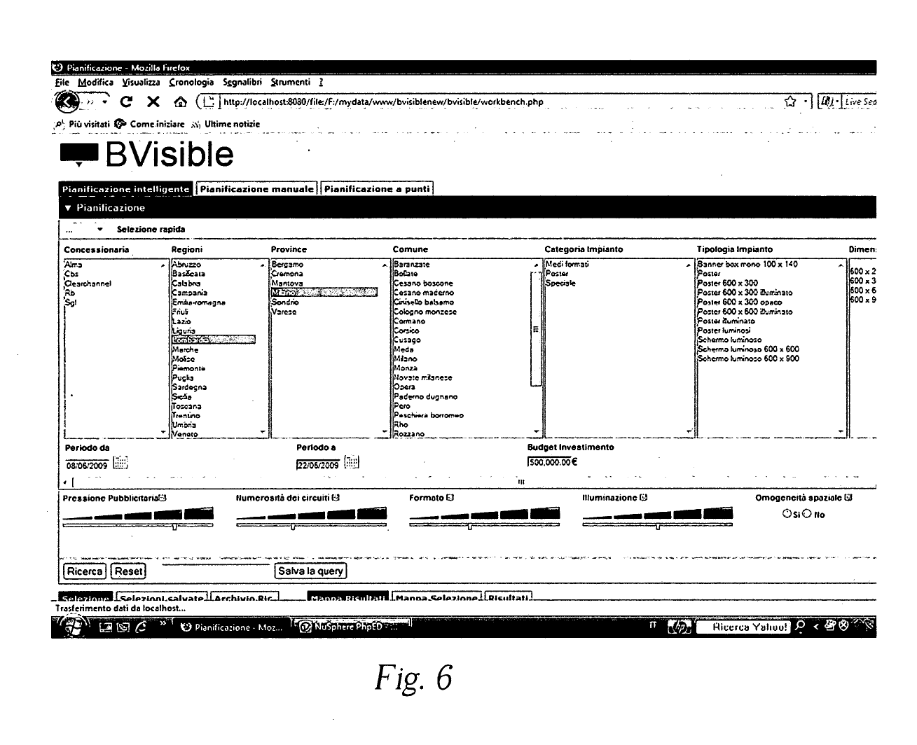

With reference to FIGS. 6, 7 and 8, a possible embodiment of a user interface that can be adopted by a computer of a user of the service 30 or 31 to enter the parameters of a query to the server and for the subsequent viewing of the results of said query is now described.

FIG. 6 is a view of a data entry interface for planning an advertising campaign by using the scoring and selection algorithms described above.

The user can delimit the results to a subset of circuits, selecting them by agent, region, province, city, type or others. Moreover, the user, at his own discretion, can define the budget to be allocated and the period over which the campaign is to be organized.

By acting on the controls shown in the lower part of the screen, it is further possible to set some criteria, assigning a weight to each one, such as advertising pressure, whose value is inversely proportional to the price, circuit numerosity, i.e., the number of sites of a circuit, the poster format, for example maxi, medium, special, or brightness, for example ordinary billboard, backlit billboard or lit billboard. The user can also request the campaign to be as uniform as is possible on the selected territory.

Once the desired parameters have been set, the search is started by pressing the “Search” button. The results obtained by the system can be presented in a plurality of views. For example, in FIG. 6 the results are presented in summary form at the top right and in table form at the bottom right, and it is possible to add said results to a selection, which is visible on the left. It is possible to evaluate alternative selections, generating each time a new one by pressing the “New selection” button and temporarily saving the selections deemed interesting; once a satisfactory selection has been determined, it is possible to send a request to the system by pressing the “Send request” button.

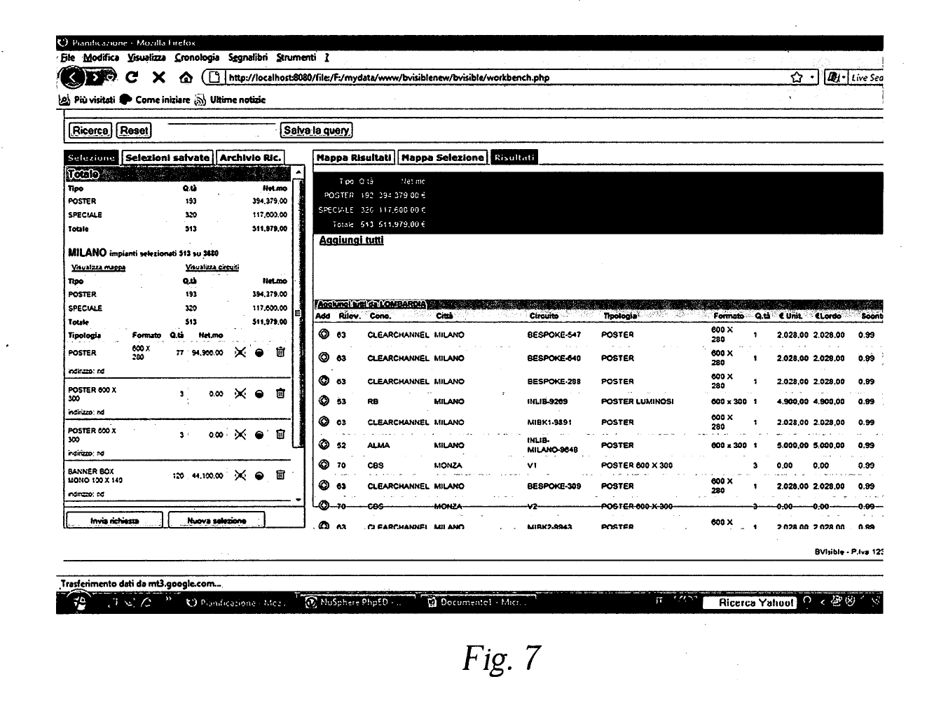

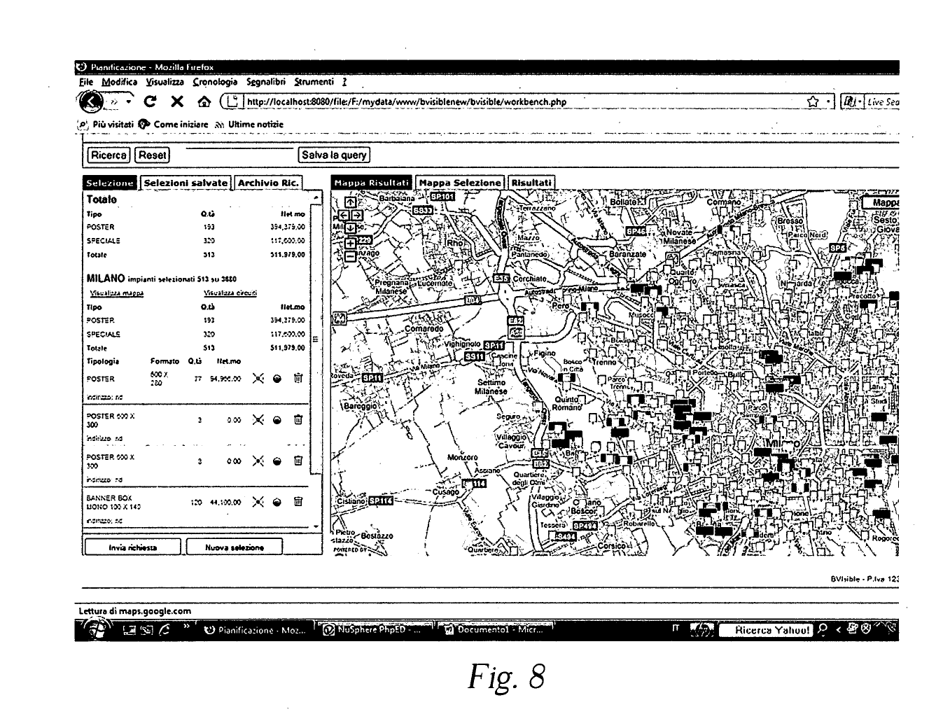

FIG. 8, which can be accessed by selecting the “Results map” tab shown in FIG. 7, illustrates graphically the location on the territory of the circuits that belong to the current selection, based on maps supplied by external engines, for example by the engine of Google™.

In a preferred embodiment, the system provides for site selection methods that are alternative to the automatic planning described above. This planning can be for example integrated with or replaced by manual planning, which allows to set more specific search criteria, for example search in sites of a particular circuit. It is further possible to provide a type of planning that is based on georeferentiation: in this case, the user explicitly enters the addresses of the desired sites.

The person skilled in the art easily understands that the methods of embodiment described above can be implemented in different manners and that the present invention therefore is not limited to a particular implementation.

It has thus been shown that the present invention overcomes the qualitative limitations of the background art, allowing the automatic execution of advertising campaigns in short times, assessed on the basis of uniform data, overcoming the limitations of the background art.

Clearly, numerous modifications are clear and can be performed promptly by the person skilled in the art without abandoning the protective scope of the present invention. It is also evident that the inventive concept on which the present invention is based is independent of the actual implementation of the software modules, which can be provided in any language and on any hardware platform.

Therefore, the scope of the protection of the claims must not be limited by the illustrations or by the preferred embodiments shown in the description by way of example, but rather the claims must comply is all the characteristics of patentable novelty that reside within the present invention, including all the characteristics that would be treated as equivalent by the person skilled in the art.

1-19. (canceled)

20. A system for telematic management of advertising campaigns, comprising:
a central server connected to a database that contains identification data of advertising sites associated with a plurality of operators, said identification data comprising operating parameters associated with each one of said sites;
a plurality of user stations, suitable to interact with said central server via a telematic network and comprising a data entry interface for defining an advertising campaign;
a processing engine, located at said central server, which is configured to associate automatically with said advertising campaign, on the basis of said definition data of said advertising campaign and of said identification data, one or more of said advertising sites.

21. The system for telematic management of advertising campaigns according to claim 20, further comprising an engine for the acquisition of said identification data of advertising sites, said conversion engine comprising a plurality of translation schemes for the translation into a common code of identification data coded on proprietary schemes of said operators.

22. The system for telematic management of advertising campaigns according to claim 20, wherein said identification data of said sites comprise geographical position data and type and size data.

23. The system for telematic management of advertising campaigns according to claim 22, wherein said operating parameters comprise public parameters, which can be set by said client stations, private parameters, which can be set by said operators, and confidential parameters, which can be set by the operator of said central server.

24. The system for telematic management of advertising campaigns according to claim 23, wherein said public parameters comprise one or more among site dimensions, site unit price, site GRP, site coverage, discount.

25. The system for telematic management of advertising campaigns according to claim 24, wherein said private parameters comprise one or more between the annual unsold percentage and the period unsold percentage.

26. The system for telematic management of advertising campaigns according to claim 25, wherein said confidential parameters comprise one or more between residual annual agent value and period residual agent value.

27. The system for telematic management of advertising campaigns according to claim 23, wherein said data for defining an advertising campaign comprise geographical location data, duration data and cost data of the campaign.

28. The system for telematic management of advertising campaigns according to claim 27, wherein said processing engine comprises a rating module that is programmed to chart said advertising sites on the basis of said identification data and a selection module that is programmed to select a plurality of said sites on the basis of said definition data of an advertising campaign and of said chart.

29. A processing engine of the system for telematic management of advertising campaigns according to claim 20.

30. A method for telematic management of advertising campaigns, comprising the steps that consist in:
gathering in a database, located at a central server and connected to a telematic network, identification data of advertising sites associated with a plurality of operators, said identification data comprising operating parameters associated with each one of said sites;
receiving, from a plurality of user stations suitable to interact with said central server via said telematic network, data for defining an advertising campaign;
on the basis of said definition data of said advertising campaign and of said identification data, associating one or more of said advertising sites with said advertising campaign.

31. The method for telematic management of advertising campaigns according to claim 30, wherein said identification data of advertising sites are acquired by converting identification data coded on proprietary schemes of said operators into a common coding.

32. The method for telematic management of advertising campaigns according to claim 30, including, among said identification data of said sites, geographical location data and type and size data.

33. The method for telematic management of advertising campaigns according to claim 32, wherein said operating parameters are divided into public parameters, which can be set by said client stations, private parameters, which can be set by said operators, and confidential parameters, which can be set by an operator of said central server.

34. The method for telematic management of advertising campaigns according to claim 33, further including, in said public parameters, one or more among site dimensions, site unit price, site GRP, site coverage, and discount.

35. The method for telematic management of advertising campaigns according to claim 34, wherein said private parameters comprise one or more between annual unsold percentage and period unsold percentage.

36. The method for telematic management of advertising campaigns according to claim 35, further including, in said confidential parameters, one or more among the annual residual agent value and the period residual agent value.

37. The method for telematic management of advertising campaigns according to claim 36, further including, in said definition data of an advertising campaign, geographical location data, duration data and campaign cost data.

38. The method for telematic management of advertising campaigns according to claim 37, further comprising the steps that consist in:
rating said advertising sites on the basis of said identification data;
selecting a plurality of said sites on the basis of said definition data of an advertising campaign and of said rating.
